(19) United States
(12) Patent Application Publication
(10) Pub. No.: US 2025/0131404 A1
(43) Pub. Date: Apr. 24, 2025

(54) Method, System, and Computer Program Product for Processing a Group Payment Credential

(71) Applicant: Visa International Service Association, San Francisco, CA (US)

(72) Inventors: Solomon Alexander Taylor, Oakland, CA (US); Jude Chukwuemeka Ogbuibe, San Jose, CA (US); Winston Wills, JR., Oakley, CA (US)

(21) Appl. No.: 18/493,101

(22) Filed: Oct. 24, 2023

(51) Int. Cl. G06Q 20/22; G06Q 20/38; G06Q 30/0207

(52) U.S. Cl. CPC G06Q 20/227; G06Q 20/29; G06Q 20/3821; G06Q 30/0213

(57) ABSTRACT

A computer-implemented method may include issuing a group payment credential to a payment group including a plurality of users, each user having an individual payment credential associated with a payment device; receiving a group payment request initiated using the group payment credential, the group payment request associated with a payment transaction having a transaction amount; in response to receiving the group payment request, identifying payment device data associated with the individual payment credentials of each user in the payment group; determining a first individual payment credential from the individual payment credentials based on the payment device data associated with the individual payment credentials and transaction data associated with the payment transaction; generating a processing request including the first individual payment credential; and transmitting the processing request to an issuer system corresponding to the first individual payment credential to cause the issuer system to process the payment transaction.

### BACKGROUND

### 1. Field

This disclosure relates generally to processing payment credentials, and, in some non-limiting embodiments or aspects, to methods, systems, and computer program products for processing group payment credentials.

### 2. Technical Considerations

There is an increase in group spending payment transactions. However, there is no existing technology to efficiently initiate and settle in real-time group spending payment transactions leveraging the capabilities of an electronic payment network. Instead, merchants are left to split checks of a group spending payment transactions, or the group members themselves must manually settle the transaction after its completion.

### SUMMARY

Accordingly, it is an object of the present disclosure to provide systems, methods, and computer program products for processing a group payment credential that overcome some or all of the deficiencies identified above.

According to non-limiting embodiments or aspects, provided is a computer-implemented method including: issuing, with at least one processor, a group payment credential to a payment group including a plurality of users, each user including an individual payment credential associated with a payment device, the group payment credential configured to initiate electronic payment transactions of the payment group; receiving, with at least one processor, a group payment request initiated using the group payment credential, the group payment request associated with a payment transaction having a transaction amount; in response to receiving the group payment request, identifying, with at least one processor, payment device data associated with the individual payment credentials of each user in the payment group; determining, with at least one processor, a first individual payment credential from the individual payment credentials based on the payment device data associated with the individual payment credentials and transaction data associated with the payment transaction; generating, with at least one processor, a processing request including the first individual payment credential; and transmitting, with at least one processor, the processing request to an issuer system corresponding to the first individual payment credential to cause the issuer system to process the payment transaction.

In some non-limiting embodiments or aspects, determining the first individual payment credential may include: determining a reward amount for each of the individual payment credentials based on the payment device data associated with the individual payment credentials and the transaction data associated with the payment transaction; determining that the first individual payment credential has a highest reward amount compared the other individual payment credentials, where the reward amount for the first individual payment credential may include a first reward amount.

In some non-limiting embodiments or aspects, the computer-implemented method may further include during settlement of the payment transaction: determining, with at least one processor, an apportionment of the first reward amount among the plurality of users; and automatically crediting, with at least one processor, each account of the plurality of users with a corresponding apportionment of the first reward amount.

In some non-limiting embodiments or aspects, the computer-implemented method may further include: initiating, with a first user device associated with a first user in the payment group, the payment transaction by generating and transmitting a transaction proposal message to each second user device of a plurality of second users in the payment group, the transaction proposal message including an apportionment of the transaction amount for each user in the payment group; receiving a transaction proposal response from each of the second user devices, the transaction proposal responses including a transaction approval indicator; and generating and transmitting the group payment request.

In some non-limiting embodiments or aspects, the group payment request may not include the first individual payment credential.

In some non-limiting embodiments or aspects, the first individual payment credential may correspond to a first user in the payment group, where the payment group may include at least one second user, the at least one second user having a second individual payment credential issued by at least one second issuer system, where each user in the payment group may be apportioned a portion of the transaction amount, the computer-implemented method may further include: for each user of the at least one second user, authorizing, with the at least one second issuer system, the second user for the corresponding apportioned portion of the transaction amount; and initiating clearing and/or settlement of the payment transaction.

In some non-limiting embodiments or aspects, the computer-implemented method may further include: for each user the at least one second user, automatically placing, with the at least one second issuer system, a hold on a payment account associated with the second user for the corresponding apportioned portion of the transaction amount.

In some non-limiting embodiments or aspects, a unique identifier associated with the payment transaction may be stored in association with each hold placed on the payment account associated with the at least one second user, the computer-implemented method may further include: for each user of the at least one second user: receiving, with the at least one second issuer system, a hold release message including the unique identifier; and automatically releasing, with the at least one second issuer system, the hold on the payment account associated with the second user based on the unique identifier in the hold release message matching the unique identifier stored in association with the hold.

In some non-limiting embodiments or aspects, clearing and/or settlement of the payment transaction may include: automatically debiting, with at least one processor, the corresponding apportioned portion of the transaction amount from a payment account associated with each of the at least one second user; and automatically crediting, with at least one processor, a payment account of the first user at least a portion of the amount debited from the payment accounts associated with the at least one second user.

In some non-limiting embodiments or aspects, the automatic debiting and/or the automatic crediting may be executed in real-time relative to clearing and/or settlement of the transaction amount with a merchant system with a payment account associated with the first individual payment credential.

According to non-limiting embodiments or aspects, provided is a system including at least one processor programmed or configured to: issue a group payment credential to a payment group including a plurality of users, each user including an individual payment credential associated with a payment device, the group payment credential configured to initiate electronic payment transactions of the payment group; receive a group payment request initiated using the group payment credential, the group payment request associated with a payment transaction having a transaction amount; in response to receiving the group payment request, identify payment device data associated with the individual payment credentials of each user in the payment group; determine a first individual payment credential from the individual payment credentials based on the payment device data associated with the individual payment credentials and transaction data associated with the payment transaction; generate a processing request including the first individual payment credential; and transmit the processing request to an issuer system corresponding to the first individual payment credential to cause the issuer system to process the payment transaction.

In some non-limiting embodiments or aspects, determining the first individual payment credential may include: determining a reward amount for each of the individual payment credentials based on the payment device data associated with the individual payment credentials and the transaction data associated with the payment transaction; determining that the first individual payment credential has a highest reward amount compared the other individual payment credentials, where the reward amount for the first individual payment credential may include a first reward amount.

In some non-limiting embodiments or aspects, the at least one processor may be programmed or configured, during settlement of the payment transaction, to: determine an apportionment of the first reward amount among the plurality of users; and automatically credit each account of the plurality of users with a corresponding apportionment of the first reward amount.

In some non-limiting embodiments or aspects, the at least one processor may be programmed or configured to: initiate, with a first user device associated with a first user in the payment group, the payment transaction by generating and transmitting a transaction proposal message to each second user device of a plurality of second users in the payment group, the transaction proposal message including an apportionment of the transaction amount for each user in the payment group; receive a transaction proposal response from each of the second user devices, the transaction proposal responses including a transaction approval indicator; and generate and transmit the group payment request.

In some non-limiting embodiments or aspects, the group payment request may not include the first individual payment credential.

In some non-limiting embodiments or aspects, the first individual payment credential may correspond to a first user in the payment group, where the payment group may include at least one second user, the at least one second user having a second individual payment credential issued by at least one second issuer system, where each user in the payment group may be apportioned a portion of the transaction amount, where the at least one processor may be programmed or configured to: for each user of the at least one second user, authorize, with the at least one second issuer system, the second user for the corresponding apportioned portion of the transaction amount; and initiate clearing and/or settlement of the payment transaction.

In some non-limiting embodiments or aspects, the at least one processor may be programmed or configured to: for each user the at least one second user, automatically place, with the at least one second issuer system, a hold on a payment account associated with the second user for the corresponding apportioned portion of the transaction amount.

In some non-limiting embodiments or aspects, a unique identifier associated with the payment transaction may be stored in association with each hold placed on the payment account associated with the at least one second user, where the at least one processor may be programmed or configured to: for each user of the at least one second user: receive, with the at least one second issuer system, a hold release message including the unique identifier; and automatically release, with the at least one second issuer system, the hold on the payment account associated with the second user based on the unique identifier in the hold release message matching the unique identifier stored in association with the hold.

In some non-limiting embodiments or aspects, the at least one processor may be programmed or configured, during clearing and/or settlement of the payment transaction, to: automatically debit the corresponding apportioned portion of the transaction amount from a payment account associated with each of the at least one second user; and automatically credit a payment account of the first user at least a portion of the amount debited from the payment accounts associated with the at least one second user.

In some non-limiting embodiments or aspects, the automatic debiting and/or the automatic crediting may be executed in real-time relative to clearing and/or settlement of the transaction amount with a merchant system with a payment account associated with the first individual payment credential.

According to non-limiting embodiments or aspects, provided is a computer program product including at least one non-transitory computer-readable medium including program instructions that, when executed by at least one processor, cause the at least one processor to: issue a group payment credential to a payment group including a plurality of users, each user including an individual payment credential associated with a payment device, the group payment credential configured to initiate electronic payment transactions of the payment group; receive a group payment request initiated using the group payment credential, the group payment request associated with a payment transaction having a transaction amount; in response to receiving the group payment request, identify payment device data associated with the individual payment credentials of each user in the payment group; determine a first individual payment credential from the individual payment credentials based on the payment device data associated with the individual payment credentials and transaction data associated with the payment transaction; generate a processing request including the first individual payment credential; and transmit the processing request to an issuer system corresponding to the first individual payment credential to cause the issuer system to process the payment transaction.

In some non-limiting embodiments or aspects, determining the first individual payment credential may include: determining a reward amount for each of the individual payment credentials based on the payment device data associated with the individual payment credentials and the transaction data associated with the payment transaction; determining that the first individual payment credential has a highest reward amount compared the other individual payment credentials, where the reward amount for the first individual payment credential may include a first reward amount.

In some non-limiting embodiments or aspects, the program instructions may further cause the at least one processor, during settlement of the payment transaction, to: determine an apportionment of the first reward amount among the plurality of users; and automatically credit each account of the plurality of users with a corresponding apportionment of the first reward amount.

In some non-limiting embodiments or aspects, the program instructions may further cause the at least one processor to: initiate, with a first user device associated with a first user in the payment group, the payment transaction by generating and transmitting a transaction proposal message to each second user device of a plurality of second users in the payment group, the transaction proposal message including an apportionment of the transaction amount for each user in the payment group; receive a transaction proposal response from each of the second user devices, the transaction proposal responses including a transaction approval indicator; and generate and transmit the group payment request.

In some non-limiting embodiments or aspects, the group payment request may not include the first individual payment credential.

In some non-limiting embodiments or aspects, the first individual payment credential may correspond to a first user in the payment group, where the payment group may include at least one second user, the at least one second user having a second individual payment credential issued by at least one second issuer system, where each user in the payment group may be apportioned a portion of the transaction amount, where the program instructions may further cause the at least one processor to: for each user of the at least one second user, authorize, with the at least one second issuer system, the second user for the corresponding apportioned portion of the transaction amount; and initiate clearing and/or settlement of the payment transaction.

In some non-limiting embodiments or aspects, the program instructions may further cause the at least one processor to: for each user the at least one second user, automatically place, with the at least one second issuer system, a hold on a payment account associated with the second user for the corresponding apportioned portion of the transaction amount.

In some non-limiting embodiments or aspects, a unique identifier associated with the payment transaction may be stored in association with each hold placed on the payment account associated with the at least one second user, where the program instructions may further cause the at least one processor to: for each user of the at least one second user: receive, with the at least one second issuer system, a hold release message including the unique identifier; and automatically release, with the at least one second issuer system, the hold on the payment account associated with the second user based on the unique identifier in the hold release message matching the unique identifier stored in association with the hold.

In some non-limiting embodiments or aspects, the program instructions may further cause the at least one processor, during clearing and/or settlement of the payment transaction, to: automatically debit the corresponding apportioned portion of the transaction amount from a payment account associated with each of the at least one second user; and automatically credit a payment account of the first user at least a portion of the amount debited from the payment accounts associated with the at least one second user.

In some non-limiting embodiments or aspects, the automatic debiting and/or the automatic crediting may be executed in real-time relative to clearing and/or settlement of the transaction amount with a merchant system with a payment account associated with the first individual payment credential.

Other non-limiting embodiments or aspects will be set forth in the following numbered clauses:
Clause 1: A computer-implemented method comprising: issuing, with at least one processor, a group payment credential to a payment group comprising a plurality of users, each user comprising an individual payment credential associated with a payment device, the group payment credential configured to initiate electronic payment transactions of the payment group; receiving, with at least one processor, a group payment request initiated using the group payment credential, the group payment request associated with a payment transaction having a transaction amount; in response to receiving the group payment request, identifying, with at least one processor, payment device data associated with the individual payment credentials of each user in the payment group; determining, with at least one processor, a first individual payment credential from the individual payment credentials based on the payment device data associated with the individual payment credentials and transaction data associated with the payment transaction; generating, with at least one processor, a processing request comprising the first individual payment credential; and transmitting, with at least one processor, the processing request to an issuer system corresponding to the first individual payment credential to cause the issuer system to processing the payment transaction.
Clause 2: The computer-implemented method of clause 1, wherein determining the first individual payment credential comprises: determining a reward amount for each of the individual payment credentials based on the payment device data associated with the individual payment credentials and the transaction data associated with the payment transaction; determining that the first individual payment credential has a highest reward amount compared the other individual payment credentials, wherein the reward amount for the first individual payment credential comprises a first reward amount.
Clause 3: The computer-implemented method of clause 1 or 2, further comprising during settlement of the payment transaction: determining, with at least one processor, an apportionment of the first reward amount among the plurality of users; and automatically crediting, with at least one processor, each account of the plurality of users with a corresponding apportionment of the first reward amount.
Clause 4: The computer-implemented method of any of clauses 1-3, further comprising: initiating, with a first user device associated with a first user in the payment group, the payment transaction by generating and transmitting a transaction proposal message to each second user device of a plurality of second users in the payment group, the transaction proposal message comprising an apportionment of the transaction amount for each user in the payment group; receiving a transaction proposal response from each of the second user devices, the transaction proposal responses comprising a transaction approval indicator; and generating and transmitting the group payment request.
Clause 5: The computer-implemented method of any of clauses 1-4, wherein the group payment request does not comprise the first individual payment credential.
Clause 6: The computer-implemented method of any of clauses 1-5, wherein the first individual payment credential corresponds to a first user in the payment group, wherein the payment group comprises at least one second user, the at least one second user having a second individual payment credential issued by at least one second issuer system, wherein each user in the payment group is apportioned a portion of the transaction amount, the computer-implemented method further comprising: for each user of the at least one second user, authorizing, with the at least one second issuer system, the second user for the corresponding apportioned portion of the transaction amount; and initiating clearing and/or settlement of the payment transaction.
Clause 7: The computer-implemented method of any of clauses 1-6, further comprising: for each user the at least one second user, automatically placing, with the at least one second issuer system, a hold on a payment account associated with the second user for the corresponding apportioned portion of the transaction amount.
Clause 8: The computer-implemented method of any of clauses 1-7, wherein a unique identifier associated with the payment transaction is stored in association with each hold placed on the payment account associated with the at least one second user, the computer-implemented method further comprising: for each user of the at least one second user: receiving, with the at least one second issuer system, a hold release message comprising the unique identifier; and automatically releasing, with the at least one second issuer system, the hold on the payment account associated with the second user based on the unique identifier in the hold release message matching the unique identifier stored in association with the hold.
Clause 9: The computer-implemented method of any of clauses 1-8, wherein clearing and/or settlement of the payment transaction comprises: automatically debiting, with at least one processor, the corresponding apportioned portion of the transaction amount from a payment account associated with each of the at least one second user; and automatically crediting, with at least one processor, a payment account of the first user at least a portion of the amount debited from the payment accounts associated with the at least one second user.
Clause 10: The computer-implemented method of any of clauses 1-9, wherein the automatic debiting and/or the automatic crediting are executed in real-time relative to clearing and/or settlement of the transaction amount with a merchant system with a payment account associated with the first individual payment credential.
Clause 11: A system comprising at least one processor programmed or configured to: issue a group payment credential to a payment group comprising a plurality of users, each user comprising an individual payment credential associated with a payment device, the group payment credential configured to initiate electronic payment transactions of the payment group; receive a group payment request initiated using the group payment credential, the group payment request associated with a payment transaction having a transaction amount; in response to receiving the group payment request, identify payment device data associated with the individual payment credentials of each user in the payment group; determine a first individual payment credential from the individual payment credentials based on the payment device data associated with the individual payment credentials and transaction data associated with the payment transaction; generate a processing request comprising the first individual payment credential; and transmit the processing request to an issuer system corresponding to the first individual payment credential to cause the issuer system to process the payment transaction.
Clause 12: The system of clause 11, wherein determining the first individual payment credential comprises: determining a reward amount for each of the individual payment credentials based on the payment device data associated with the individual payment credentials and the transaction data associated with the payment transaction; determining that the first individual payment credential has a highest reward amount compared the other individual payment credentials, wherein the reward amount for the first individual payment credential comprises a first reward amount.
Clause 13: The system of clause 11 or 12, wherein the at least one processor is programmed or configured, during settlement of the payment transaction, to: determine an apportionment of the first reward amount among the plurality of users; and automatically credit each account of the plurality of users with a corresponding apportionment of the first reward amount.
Clause 14: The system of any of clauses 11-13, wherein the at least one processor is programmed or configured to: initiate, with a first user device associated with a first user in the payment group, the payment transaction by generating and transmitting a transaction proposal message to each second user device of a plurality of second users in the payment group, the transaction proposal message comprising an apportionment of the transaction amount for each user in the payment group; receive a transaction proposal response from each of the second user devices, the transaction proposal responses comprising a transaction approval indicator; and generate and transmit the group payment request.
Clause 15: The system of any of clauses 11-14, wherein the group payment request does not comprise the first individual payment credential.
Clause 16: The system of any of clauses 11-15, wherein the first individual payment credential corresponds to a first user in the payment group, wherein the payment group comprises at least one second user, the at least one second user having a second individual payment credential issued by at least one second issuer system, wherein each user in the payment group is apportioned a portion of the transaction amount, wherein the at least one processor is programmed or configured to: for each user of the at least one second user, authorize, with the at least one second issuer system, the second user for the corresponding apportioned portion of the transaction amount; and initiate clearing and/or settlement of the payment transaction.
Clause 17: The system of any of clauses 11-16, wherein the at least one processor is programmed or configured to: for each user the at least one second user, automatically place, with the at least one second issuer system, a hold on a payment account associated with the second user for the corresponding apportioned portion of the transaction amount.
Clause 18: The system of any of clauses 11-17, wherein a unique identifier associated with the payment transaction is stored in association with each hold placed on the payment account associated with the at least one second user, wherein the at least one processor is programmed or configured to: for each user of the at least one second user: receive, with the at least one second issuer system, a hold release message comprising the unique identifier; and automatically release, with the at least one second issuer system, the hold on the payment account associated with the second user based on the unique identifier in the hold release message matching the unique identifier stored in association with the hold.
Clause 19: The system of any of clauses 11-18, wherein the at least one processor is programmed or configured, during clearing and/or settlement of the payment transaction, to: automatically debit the corresponding apportioned portion of the transaction amount from a payment account associated with each of the at least one second user; and automatically credit a payment account of the first user at least a portion of the amount debited from the payment accounts associated with the at least one second user.
Clause 20: The system of any of clauses 11-19, wherein the automatic debiting and/or the automatic crediting are executed in real-time relative to clearing and/or settlement of the transaction amount with a merchant system with a payment account associated with the first individual payment credential.
Clause 21: A computer program product comprising at least one non-transitory computer-readable medium including program instructions that, when executed by at least one processor, cause the at least one processor to: issue a group payment credential to a payment group comprising a plurality of users, each user comprising an individual payment credential associated with a payment device, the group payment credential configured to initiate electronic payment transactions of the payment group; receive a group payment request initiated using the group payment credential, the group payment request associated with a payment transaction having a transaction amount; in response to receiving the group payment request, identify payment device data associated with the individual payment credentials of each user in the payment group; determine a first individual payment credential from the individual payment credentials based on the payment device data associated with the individual payment credentials and transaction data associated with the payment transaction; generate a processing request comprising the first individual payment credential; and transmit the processing request to an issuer system corresponding to the first individual payment credential to cause the issuer system to process the payment transaction.
Clause 22: The computer program product of clause 21, wherein determining the first individual payment credential comprises: determining a reward amount for each of the individual payment credentials based on the payment device data associated with the individual payment credentials and the transaction data associated with the payment transaction; determining that the first individual payment credential has a highest reward amount compared the other individual payment credentials, wherein the reward amount for the first individual payment credential comprises a first reward amount.
Clause 23: The computer program product of clause 21 or 22, wherein the program instructions further cause the at least one processor, during settlement of the payment transaction, to: determine an apportionment of the first reward amount among the plurality of users; and automatically credit each account of the plurality of users with a corresponding apportionment of the first reward amount.
Clause 24: The computer program product of any of clauses 21-23, wherein the program instructions further cause the at least one processor to: initiate, with a first user device associated with a first user in the payment group, the payment transaction by generating and transmitting a transaction proposal message to each second user device of a plurality of second users in the payment group, the transaction proposal message comprising an apportionment of the transaction amount for each user in the payment group; receive a transaction proposal response from each of the second user devices, the transaction proposal responses comprising a transaction approval indicator; and generate and transmit the group payment request.
Clause 25: The computer program product of any of clauses 21-24, wherein the group payment request does not comprise the first individual payment credential.
Clause 26: The computer program product of any of clauses 21-25, wherein the first individual payment credential corresponds to a first user in the payment group, wherein the payment group comprises at least one second user, the at least one second user having a second individual payment credential issued by at least one second issuer system, wherein each user in the payment group is apportioned a portion of the transaction amount, wherein the program instructions further cause the at least one processor to: for each user of the at least one second user, authorize, with the at least one second issuer system, the second user for the corresponding apportioned portion of the transaction amount; and initiate clearing and/or settlement of the payment transaction.
Clause 27: The computer program product of any of clauses 21-26, wherein the program instructions further cause the at least one processor to: for each user the at least one second user, automatically place, with the at least one second issuer system, a hold on a payment account associated with the second user for the corresponding apportioned portion of the transaction amount.
Clause 28: The computer program product of any of clauses 21-27, wherein a unique identifier associated with the payment transaction is stored in association with each hold placed on the payment account associated with the at least one second user, wherein the program instructions further cause the at least one processor to: for each user of the at least one second user: receive, with the at least one second issuer system, a hold release message comprising the unique identifier; and automatically release, with the at least one second issuer system, the hold on the payment account associated with the second user based on the unique identifier in the hold release message matching the unique identifier stored in association with the hold.
Clause 29: The computer program product of any of clauses 21-28, wherein the program instructions further cause the at least one processor, during clearing and/or settlement of the payment transaction, to: automatically debit the corresponding apportioned portion of the transaction amount from a payment account associated with each of the at least one second user; and automatically credit a payment account of the first user at least a portion of the amount debited from the payment accounts associated with the at least one second user.
Clause 30: The computer program product of any of clauses 21-29, wherein the automatic debiting and/or the automatic crediting are executed in real-time relative to clearing and/or settlement of the transaction amount with a merchant system with a payment account associated with the first individual payment credential.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosed subject matter.

### BRIEF DESCRIPTION OF THE DRAWINGS

Additional advantages and details are explained in greater detail below with reference to the non-limiting, exemplary embodiments that are illustrated in the accompanying schematic figures, in which:

FIG. 1 is a schematic diagram of a system for issuing a group payment credential to a payment group according to some non-limiting embodiments or aspects;

FIGS. 2A-2C are graphical user interfaces displayed on user devices for initiating group payment transactions according to some non-limiting embodiments or aspects;

FIG. 3 is a schematic diagram of a system for authenticating and/or authorizing a group payment transaction according to some non-limiting embodiments or aspects;

FIG. 4 is a schematic diagram of a reward data structure according to some non-limiting embodiments or aspects;

FIG. 5 is a schematic diagram of a system for processing a group payment transaction according to some non-limiting embodiments or aspects;

FIG. 6 is a step diagram of a computer-implemented method for processing a group payment credential according to some non-limiting embodiments or aspects; and

FIG. 7 illustrates example components of a device used in connection with non-limiting embodiments or aspects.

### DETAILED DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the embodiments as they are oriented in the drawing figures. However, it is to be understood that the embodiments may assume various alternative variations and step sequences, except where expressly specified to the contrary. It is also to be understood that the specific devices and processes illustrated in the attached drawings, and described in the following specification, are simply exemplary embodiments or aspects of the disclosed subject matter. Hence, specific dimensions and other physical characteristics related to the embodiments or aspects disclosed herein are not to be considered as limiting.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise.

As used herein, the term “account identifier” may include one or more primary account numbers (PANs), tokens, or other identifiers associated with a customer account. The term “token” may refer to an identifier that is used as a substitute or replacement identifier for an original account identifier, such as a PAN. Account identifiers may be alphanumeric or any combination of characters and/or symbols. Tokens may be associated with a PAN or other original account identifier in one or more data structures (e.g., one or more databases, and/or the like) such that they may be used to conduct a transaction without directly using the original account identifier. In some examples, an original account identifier, such as a PAN, may be associated with a plurality of tokens for different individuals or purposes.

As used herein, the term “acquirer institution” may refer to an entity licensed and/or approved by a transaction service provider to originate transactions (e.g., payment transactions) using a payment device associated with the transaction service provider. The transactions the acquirer institution may originate may include payment transactions (e.g., purchases, original credit transactions (OCTs), account funding transactions (AFTs), and/or the like). In some non-limiting embodiments or aspects, an acquirer institution may be a financial institution, such as a bank. As used herein, the term “acquirer system” may refer to one or more computing devices operated by or on behalf of an acquirer institution, such as a server computer executing one or more software applications.

An “application program interface” (API) refers to computer code or other data sorted on a computer-readable medium that may be executed by a processor to facilitate the interaction between software components, such as a client-side front-end and/or server-side back-end for receiving data from the client. An “interface” refers to a generated display, such as one or more graphical user interfaces (GUIs) with which a user may interact, either directly or indirectly (e.g., through a keyboard, mouse, etc.).

As used herein, the terms “client” and “client device” may refer to one or more client-side devices or systems (e.g., remote from a transaction service provider) used to initiate or facilitate a transaction (e.g., a payment transaction). As an example, a “client device” may refer to one or more point-of-sale (POS) devices used by a merchant, one or more acquirer host computers used by an acquirer, one or more mobile devices used by a user, one or more computing devices used by a payment device provider system, and/or the like. In some non-limiting embodiments or aspects, a client device may be an electronic device configured to communicate with one or more networks and initiate or facilitate transactions. For example, a client device may include one or more computers, portable computers, laptop computers, tablet computers, mobile devices, cellular phones, wearable devices (e.g., watches, glasses, lenses, clothing, and/or the like), PDAs, and/or the like. Moreover, a “client” may also refer to an entity (e.g., a merchant, an acquirer, and/or the like) that owns, utilizes, and/or operates a client device for initiating transactions (e.g., for initiating transactions with a transaction service provider).

As used herein, the term “communication” may refer to the reception, receipt, transmission, transfer, provision, and/or the like of data (e.g., information, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit processes information received from the first unit and communicates the processed information to the second unit.

As used herein, the term “computing device” may refer to one or more electronic devices configured to process data. A computing device may, in some examples, include the necessary components to receive, process, and output data, such as a processor, a display, a memory, an input device, a network interface, and/or the like. A computing device may be a mobile device. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. A computing device may also be a desktop computer or other form of non-mobile computer.

As used herein, the terms “electronic wallet” and “electronic wallet application” refer to one or more electronic devices and/or software applications configured to initiate and/or conduct payment transactions. For example, an electronic wallet may include a mobile device executing an electronic wallet application, and may further include server-side software and/or databases for maintaining and providing transaction data to the mobile device. An “electronic wallet provider” may include an entity that provides and/or maintains an electronic wallet for a customer, such as Google Pay®, Apple Pay®, Samsung Pay®, and/or other like electronic payment systems. In some non-limiting examples, an issuer bank may be an electronic wallet provider.

As used herein, the term “issuer institution” may refer to one or more entities, such as a bank, that provide accounts to customers for conducting transactions (e.g., payment transactions), such as initiating credit and/or debit payments. For example, an issuer institution may provide an account identifier, such as a PAN, to a customer that uniquely identifies one or more accounts associated with that customer. The account identifier may be embodied on a portable financial device, such as a physical financial instrument, e.g., a payment card, and/or may be electronic and used for electronic payments. The term “issuer system” refers to one or more computer devices operated by or on behalf of an issuer institution, such as a server computer executing one or more software applications. For example, an issuer system may include one or more authorization servers for authorizing a transaction.

As used herein, the term “merchant” may refer to an individual or entity that provides goods and/or services, or access to goods and/or services, to customers based on a transaction, such as a payment transaction. The term “merchant” or “merchant system” may also refer to one or more computer systems operated by or on behalf of a merchant, such as a server computer executing one or more software applications.

As used herein, the term “payment device” may refer to a payment card (e.g., a credit or debit card), a gift card, a smartcard, smart media, a payroll card, a healthcare card, a wristband, a machine-readable medium containing account information, a keychain device or fob, an RFID transponder, a retailer discount or loyalty card, a cellular phone, an electronic wallet mobile application, a PDA, a pager, a security card, a computing device, an access card, a wireless terminal, a transponder, and/or the like. In some non-limiting embodiments or aspects, the payment device may include volatile or non-volatile memory to store information (e.g., an account identifier, a name of the account holder, and/or the like).

As used herein, the term “payment gateway” may refer to an entity and/or a payment processing system operated by or on behalf of such an entity (e.g., a merchant service provider, a payment service provider, a payment facilitator, a payment facilitator that contracts with an acquirer, a payment aggregator, and/or the like), which provides payment services (e.g., transaction service provider payment services, payment processing services, and/or the like) to one or more merchants. The payment services may be associated with the use of payment devices managed by a transaction service provider. As used herein, the term “payment gateway system” may refer to one or more computer systems, computer devices, servers, groups of servers, and/or the like, operated by or on behalf of a payment gateway.

As used herein, a “point-of-sale (POS) device” may refer to one or more devices, which may be used by a merchant to conduct a transaction (e.g., a payment transaction) and/or process a transaction. For example, a POS device may include one or more client devices. Additionally or alternatively, a POS device may include peripheral devices, card readers, scanning devices (e.g., code scanners), Bluetooth® communication receivers, near-field communication (NFC) receivers, radio frequency identification (RFID) receivers, and/or other contactless transceivers or receivers, contact-based receivers, payment terminals, and/or the like. As used herein, a “point-of-sale (POS) system” may refer to one or more client devices and/or peripheral devices used by a merchant to conduct a transaction. For example, a POS system may include one or more POS devices and/or other like devices that may be used to conduct a payment transaction. In some non-limiting embodiments or aspects, a POS system (e.g., a merchant POS system) may include one or more server computers programmed or configured to process online payment transactions through webpages, mobile applications, and/or the like.

As used herein, the term “server” may refer to or include one or more computing devices that are operated by or facilitate communication and processing for multiple parties in a network environment, such as the internet, although it will be appreciated that communication may be facilitated over one or more public or private network environments and that various other arrangements are possible. Further, multiple computing devices (e.g., servers, POS devices, mobile devices, etc.) directly or indirectly communicating in the network environment may constitute a “system.” Reference to “a server” or “a processor,” as used herein, may refer to a previously recited server and/or processor that is recited as performing a previous step or function, a different server and/or processor, and/or a combination of servers and/or processors. For example, as used in the specification and the claims, a first server and/or a first processor that is recited as performing a first step or function may refer to the same or different server and/or a processor recited as performing a second step or function.

As used herein, the term “transaction service provider” may refer to an entity that receives transaction authorization requests from merchants or other entities and provides guarantees of payment, in some cases through an agreement between the transaction service provider and an issuer institution. For example, a transaction service provider may include a payment network such as Visa® or any other entity that processes transactions. The term “transaction processing system” may refer to one or more computer systems operated by or on behalf of a transaction service provider, such as a transaction processing server executing one or more software applications. A transaction processing server may include one or more processors and, in some non-limiting embodiments or aspects, may be operated by or on behalf of a transaction service provider.

Non-limiting embodiments or aspects of the disclosed subject matter are directed to systems, methods, and computer program products for processing a group payment credential. Non-limiting embodiments or aspects execute a group payment transaction (e.g., electronic payment transaction) for a group that is splitting the transaction amount amongst group members. The group payment transaction may be initiated by a user device of a user (e.g., of a group member) providing a group payment credential to a merchant system. The merchant system may transmit an authorization request comprising the group payment credential to a transaction processing system, which causes the transaction processing system to process the payment transaction as a group payment transaction. The transaction processing protocol may appear unchanged to the merchant system from conventional transaction processing, and the merchant system may not distinguish between individual payment credentials and group payment credentials. Instead, the merchant system may generate the authorization request by including the payment credential received, regardless of whether the payment credential is of a group or individual. This enables seamless and efficient execution of the group payment transaction without requiring hardware and/or software modifications on the part of the merchant and does not require the merchant system to employ special hardware/software or to enroll in a program in order for the group payment transaction to be processed.

Non-limiting embodiments or aspects enable the group member initiating the transaction to customize the transaction amount apportioned to each group member for the group payment transaction. Further, each user device of non-initiating group members may receive a transaction proposal message, which may enable the non-initiating group members to approve the proposed group transaction before authorization of the transaction is initiated. Non-limiting embodiments or aspects automatically identify the individual payment credentials of the group members and determine the individual payment credential to use to process the group payment transaction, such as based on the individual payment credential having the highest reward amount. The transaction may be processed using the determined individual payment credential.

Non-limiting embodiments or aspects automatically authorize the apportionment of the transaction amount for each group member prior to initiating clearing and/or settlement of the group payment transaction. The user account associated with the first individual payment credential used to authorize the group payment transaction may be used to settle the transaction amount with the merchant system. In real-time relative to the first individual payment credential settling with the merchant, the payment accounts of the other users in the group may settle with the user account associated with the first individual payment credential used to authorize the group payment transaction, thus enabling real-time reimbursement of the user's account relative to clearing and/or settlement of the transaction amount with a merchant system with a payment account associated with the first individual payment credential. Moreover, non-limiting embodiments enable automatic apportionment and disbursement of the reward amount across users of the group, as opposed to only the user whose individual payment credential was used to process the group payment transaction.

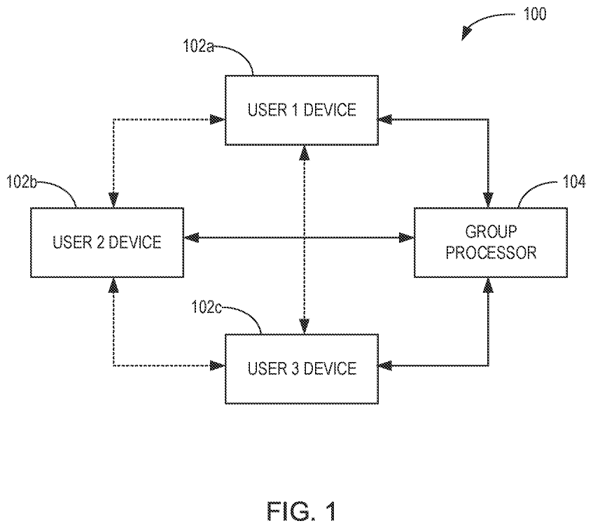

Referring to FIG. 1, shown is a system 100 for issuing a group payment credential to a payment group according to some non-limiting embodiments or aspects. The system 100 may include a plurality of user devices 102a-c of users and a group processor 104.

User devices 102a-c may include one or more devices configured to communicate, on behalf of a user, with the group processor 104. User devices 102a-c may include a computing device, such as a server (e.g., a single server), a group of servers, and/or other like devices. User devices 102a-c may initiate group payment transactions as described hereinafter.

Group processor 104 may include one or more devices configured to communicate with the user devices 102a-c. Group processor 104 may include a computing device, such as a server (e.g., a single server), a group of servers, and/or other like devices. Group processor 104 may issue group payment credentials and process group payment transactions initiated by user devices 102a-c as described hereinafter.

With continued reference to FIG. 1, system 100 may form a payment group. The group may include first, second, and third users (a plurality of users) associated with first user device 102a, second user device 102b, and third user device 102c, respectively. The group processor 104 may form the group in response to receiving a group formation request from the first user device 102a of the first user. The group may be formed by the group processor 104 transmitting a group formation message to the second user device 102b and the third user device 102c to cause a user interface thereof to display data about the proposed group and a selectable element that, when engaged by the user, indicates the user's acceptance to join the group. The selectable element may comprise a link that enables the user to confirm their acceptance to join the group. In some non-limiting embodiments, the group may be formed by the group processor 104 transmitting a group formation link to the first user device 102a, and the first user device 102a may transmit a group formation message to the second and third user devices 102b-c containing the group formation link, which enables the users to confirm their acceptance to join the group. It will be appreciated that any other suitable arrangements for enabling users to confirm acceptance to join the group may be used.

In response to each user of the group accepting the invitation to the group, the group processor 104 may automatically generate a group payment credential for the group. The group payment credential may comprise a unique identifier associated with the group. The identifier may be alphanumeric or any combination of characters and/or symbols. The group payment credential may comprise a physical payment device issued to each group member and/or a digital payment device issued to each group member, such as stored in an application of each user's user device 102a-c. The group payment credential may not have a group payment account issued to the group associated therewith, but may instead cause the group payment transaction to be executed according to the protocol described hereinafter. The group payment credential may be used to identify the users of the group, and thus their individual payment credentials. The individual payment credentials may be used in place of the group payment credential to process the group payment transaction as described hereinafter.

With continued reference to FIG. 1, the group processor 104 may issue the group payment credential to the users. For example, the group processor 104 may transmit the group payment credential to the user devices 102a-c. The user devices 102a-c may store the received group payment credential, such as in a payment application. The group payment credential issued to the group may be configured to enable the group users to initiate electronic payment transactions of the payment group from their user devices 102a-c.

Each user in the group may have at least one individual payment credential associated with a payment device issued to the user. The individual payment credential may be associated with a payment account from which a user may initiate electronic payment transactions. The individual payment credential may comprise a payment device, such as a credit card and/or debit card. The individual payment credential may comprise an account identifier associated with the payment account.

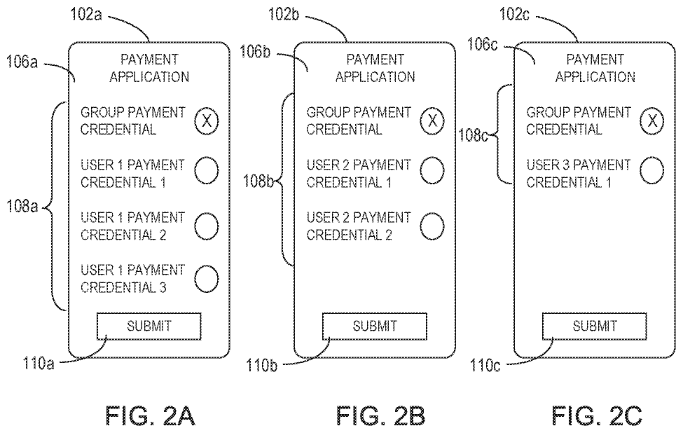

Referring to FIGS. 2A-2C graphical user interfaces displayed on user devices are shown for initiating group payment transactions according to some non-limiting embodiments or aspects. FIG. 2A shows a user interface 106a of first user device 102a; FIG. 2B shows a user interface 106b of second user device 102b; and FIG. 2C shows a user interface 106c of third user device 102c.

Each user interface 106a-c may display a payment application (e.g., a mobile payment application) comprising selectable credential elements 108a-c. The selectable credential elements 108a-c may correspond to the group payment credential issued by the group processor 104 (from FIG. 1). The selectable credential elements 108a-c may correspond to individual payment credentials of the user. For example, the first user device 102a stores 3 individual payment credentials, the second user device 102b stores 2 individual payment credentials, and the third user device 102c stores 1 individual payment credential.

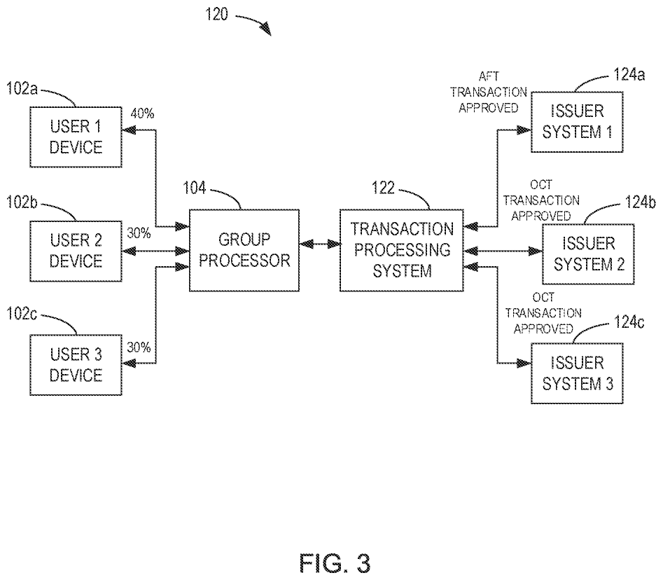

Each user interface 106a-c may display a selectable submission element 110a-c. The users of the user devices 102a-c may initiate an electronic payment transaction by engaging the selectable submission element 110a-c with a selectable credential element 108a-c selected. For example, the first user may engage the selectable submission element 110a with the group payment credential of the selectable credential element 108a selected to initiate the group payment transaction described herein. Referring to FIG. 3, a system 120 is shown for authenticating and authorizing a group payment transaction according to some non-limiting embodiments or aspects. In the system 120, the user devices 102a-c may be configured to communicate with the group processor 104. The group processor 104 may be configured to communicate with transaction processing system 122. The transaction processing system 122 may be configured to communicate with the group processor 104 and issuer systems 124a-c. The issuer systems 124a-c may be configured to communicate with transaction processing system 122.

Transaction processing system 122 may include one or more devices configured to communicate, on behalf of a transaction service provider (e.g., Visa®), with group processor 104 and the issuer systems 124a-c. Transaction processing system 122 may include a computing device, such as a server (e.g., a single server), a group of servers, and/or other like devices.

Issuer systems 124a-c may include one or more devices configured to communicate, on behalf of issuers, with transaction processing system 122. Issuer systems 124a-c may include a computing device, such as a server (e.g., a single server), a group of servers, and/or other like devices. Issuer systems 124a-c may generate authorization decisions for group payment transactions as described hereinafter.

With continued reference to FIG. 3, the first user device 102a may be the device initiating a group payment transaction. The non-limiting example of the group payment transaction described throughout the specification to illustrate various non-limiting features of the present disclosure has a transaction amount of $100, for which the first user is apportioned 40% ($40), the second user is apportioned 30% ($30), and the third user is apportioned 30% ($30). The group payment transaction is between the group of users and a merchant. It will be appreciated that other users may initiate the group payment transaction, and the group payment transaction may be for other amounts or other apportionments of the transaction amount.

The first user may initiate a group payment transaction. The first user may initiate the group payment transaction using the first user device 102a. The first user may input to a user interface of the first user device 102a (e.g., a user interface of a group payment application thereon) data associated with a proposed group payment transaction. The data may comprise proposed users of the group to be involved, a known or estimated proposed transaction amount, a proposed apportionment of the transaction amount to be assigned to each user in the group, a description of goods/services to be purchased, the merchant, the proposed transaction date, and the like. In the non-limiting example, the first user may input an apportionment to the first user device 102a of the first user apportioned 40% of the transaction amount, the second user apportioned 30% of the transaction amount, and the third user apportioned 30% of the transaction amount (see FIG. 3). In some non-limiting embodiments or aspects, the merchant system of the merchant engaged in the group payment transaction may have provided a transaction amount to the first user device 102a so that a specific dollar amount apportionment can be assigned to each user (e.g., a $100 transaction amount corresponds to a $40/$30/$40 apportionment). However, in other non-limiting embodiments, a specific dollar amount for the transaction amount may not be known at this time, such that the percentage apportionment may be used.

In response to the data input to the first user device 102a associated with the group payment transaction, the first user device 102a may generate a transaction proposal message. The transaction proposal message may comprise at least a portion of the previously described data associated with the group payment transaction.

The generated transaction proposal message may be transmitted by the first user device 102a to each user device 102b-c of the other users in the group. The first user device 102a may transmit the transaction proposal message directly to each user device 102b-c of the other users in the group, or the first user device 102a may transmit the transaction proposal message directly to the group processor 104, which may automatically transmit the transaction proposal message to each user device 102b-c of the other users in the group.

In response to receiving the transaction proposal message, each user device 102b-c may generate and display a user interface that displays at least a portion of the data contained the transaction proposal message, such as the apportionment of the proposed group transaction assigned to the user of the user device 102b-c. The user interface may comprise at least one selectable option that enables the user to engage with the user interface to accept or decline (referred to interchangeably herein as “authenticate”) the group transaction contained in the transaction proposal message. For example, the user interface may display a first selectable option to decline the group transaction and a second selectable option to accept the group transaction. It will be appreciated that the user interface may contain other user-engageable objects, such as at least one object that enables the user to modify at least one parameter of the proposed group transaction, such as an apportionment assigned to one or more users.

In response to group users selecting the first selectable option to decline the group transaction, the user device 102b-c may automatically generate a transaction proposal response comprising a decline indicator, and the user device 102b-c may transmit the transaction proposal response to the first user device 102a (directly or through the group processor 104). In response to receiving the transaction proposal response comprising a decline indicator, the group payment transaction may be automatically terminated and/or the first user may be prompted by the first user device 102a to modify the proposed group payment transaction or proceed with the transaction as an individual payment transaction.

In response to group users selecting the second selectable option to accept the group transaction, the user device 102b-c may automatically generate a transaction proposal response comprising an approval indicator, and the user device 102b-c may transmit the transaction proposal response to the first user device 102a (directly or through the group processor 104). In response to receiving transaction proposal responses comprising approval indicators from each of the user device 102b-c, the first user device 102a may automatically generate a group payment request.

The group payment request associated with the group payment transaction may comprise the group payment credential. The group payment request may comprise the transaction amount (e.g., as provided by the merchant system) and the apportionments of the transaction amount assigned to the group users. The group payment request may comprise other transaction details as previously described. The group payment request may be transmitted by the first user device 102a to the group processor 104.

The group payment request comprising the group payment credential may not comprise an individual payment credential of a user in the group, as the group processor 104 may automatically determine the individual payment credential to be used to process the group payment transaction in response to receiving the group payment request.

With continued reference to FIG. 3, in response to receiving the group payment request, the group processor 104 may identify the individual payment credentials of the users in the payment group. The group processor 104 may identify payment device data associated with the individual payment credentials of each user in the payment group. The payment device data may be identified based on data stored in a database associated with the group processor 104. The database may store data identifying the users in association with the group payment credential, such that the inclusion of the group payment credential in the group payment request enables the group processor 104 to automatically identify the users of the group. For each user in the group, the database may store the payment device data associated with the individual payment credentials of each user in association with the user. The payment device data associated with the individual payment credentials may comprise at least one of a PAN, token, expiration date, cvv code, reward data, and/or the like of a payment device issued to the individual users to initiate payment transactions.

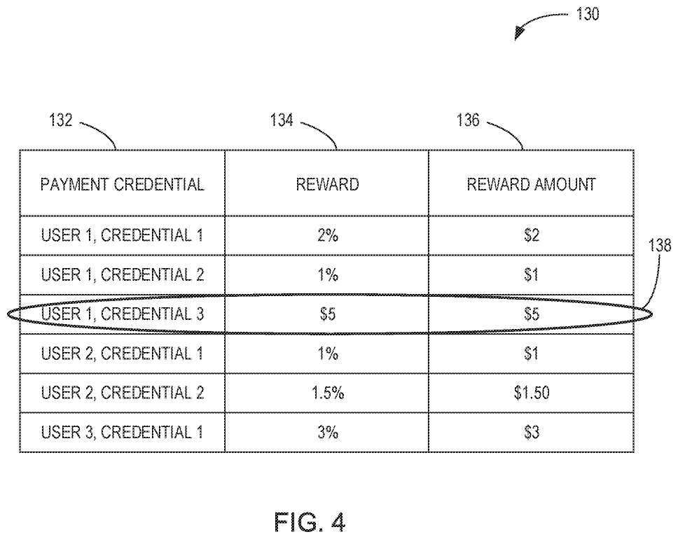

Referring to FIG. 4, a reward data structure 130 may be generated by the group processor 104 in response to the group processor 104 identifying the payment device data associated with the individual payment credentials of each user in the payment group. The reward data structure 130 may comprise the individual payment credentials 132 (e.g., the payment device data) and the reward 134 offered by each payment credential. The reward 134 may comprise at least one of a fixed or variable percentage of the transaction amount, a fixed or variable dollar amount, or any other type of reward associated with the individual payment credential. For example, the percentage of the transaction amount or the dollar amount of the rewards 134 may be based on the type of good/service purchased in the group payment transaction (e.g., a first reward percent for travel purchases and a second reward for dining purchases). Other types of reward 134 are also within the scope of this disclosure. The reward 134 may be based on the payment device data.

Based on the reward 134 and optionally the transaction amount, the group processor 104 may determine the reward amount 136 available for the group payment transaction, which may be comprised in the reward data structure 130. In the non-limiting example of the reward data structure 130 of FIG. 4, the reward amount 136 for user 1, credentials 1-2, user 2 credentials 1-2, and user 3, credential 1 may be determined based on a percentage of the transaction amount (a percentage of $100), whereas the reward amount 136 for user 1, credential 3 may be determined as a specific dollar amount.

Referring to FIGS. 3-4, the group processor 104 may determine a first individual payment credential from the individual payment credentials based on the payment device data associated with the individual payment credentials and transaction data associated with the payment transaction. In FIG. 4, the first individual payment credential is denoted by selection 138. The first individual payment credential may be the individual payment credential used to process the group payment transaction with the merchant. The first individual payment credential may be determined by the group processor 104 by the group processor 104 determining the reward amount 136 for each of the individual payment credentials based on the payment device data associated with the individual payment credentials and the transaction data associated with the payment transaction; and determining that the first individual payment credential has a highest reward amount 136 compared the other individual payment credentials. For example, in FIG. 4, the selection 138 (user 1, credential 3) has the highest reward amount 136 ($5) for the group payment transaction.

In some non-limiting embodiments or aspects, in response to the group processor 104 determining the first individual payment credential to use for processing the group payment transaction, the group processor 104 may communicate with the first user device 102a to confirm that the determined first individual payment credential should be used to process the group payment transaction. The first user device 102a may confirm use of the first individual payment credential or select a different individual payment credential to be used.

In some non-limiting embodiments or aspects, in response to the group processor 104 determining the first individual payment credential to use for processing the group payment transaction, the group processor 104 may automatically continue processing of the group payment transaction without communicating with at least one of the user devices 102a-c (e.g., first user device 102a) to confirm that the determined first individual payment credential should be used to process the group payment transaction.

With continued reference to FIGS. 3 and 4, the group processor 104 may further determine the individual payment credential to be used for the other users not associated with the first individual payment credential, which individual payment credentials may be used to settle with the user associated with the first individual payment credential. In the non-limiting example of FIGS. 3-4 the determined first individual payment credential is of the first user, such that the group processor 104 determines individual payment credentials of the second and third users. The individual payment credentials of the second and third users may be determined for the second and third users in the same manner as the first individual payment credential was determined, or any other suitable protocol for selecting the individual payment credentials may be used.

Referring again to FIG. 3, in response to the group processor 104 determining the first individual payment credential to use for processing the group payment credential and the individual payment credentials of the other users to settle with the user associated with the first individual payment credential, the group processor 104 may authorize the group payment transaction by communicating with the issuer systems 124a-c of the determined individual payment credentials to receive authorization from each.

In some non-limiting embodiments or aspects, the group processor 104 may transmit an authorization request to each issuer system 124a-c associated with the first individual payment credential and/or the other individual payment credentials used to settle with the user associated with the first individual payment credential. The authorization request may be for the corresponding apportionment of the transaction amount assigned to each user (e.g., 40%/30%/30%).

In response to receiving the authorization requests, the issuer systems 124a-c may automatically (e.g., with an authorization server thereof) authorize and/or decline the corresponding apportionment of the transaction amount. The issuer systems 124a-c may generate an authorization response comprising the authorization and/or decline decision and transmit the authorization response to the group processor 104.

In some non-limiting embodiments or aspects, based on the issuer systems 124a-c authorizing the apportionments of the transaction amount, the issuer systems 124a-c may each automatically place a hold on the payment account of the user for the apportioned transaction amount. The issuer systems 124a-c may notify the group processor 104 that the transactions have been authorized for the apportioned amounts and the holds successfully placed on the corresponding payment accounts. In some non-limiting embodiments or aspects, the holds may comprise automatically transferring (e.g., via an OCT transaction) the apportionment of the transaction amount from the user payment accounts to a pooled account in response to authorization of the apportionment amount by the issuer system 124b-c, and the apportionments may be held in the pooled account until settlement of the transaction, or the amounts may be returned by the pooled account after a predetermined period of time and/or in response to the group payment transaction being terminated.

At least one authorization code may be generated for the group payment transaction. The authorization code may be generated by the group processor 104 and/or the issuer systems 124a-c. The authorization code may comprise a unique identifier associated with the group payment transaction. A single authorization code may be generated for the group payment transaction and/or each issuer system 124a-c may generate a different authorization code for the group payment transaction. In response to the issuer systems 124a-c placing the holds on the payment accounts for the apportioned transaction amounts, the at least one authorization code may be stored by the issuer systems 124a-c in association with each hold placed by the issuer systems 124a-c, such as in databases thereof.

With continued reference to FIG. 3, the authorization request to each issuer system 124a-c associated with the first individual payment credential and/or the other individual payment credentials may be to authorize at least one of an original credit transaction (OCT), an account funding transaction (AFT), and/or the like. In some non-limiting embodiments or aspects, the transaction associated with the first individual payment credential may be an AFT transaction, and the other transactions associated with the individual payment credentials used to settle with the user associated with the first individual payment credential may be OCT transactions.

In response to the users (e.g., via the user devices 102a-c) all authenticating the group payment transaction and the issuer systems 124a-c of all users authorizing the group payment transaction and placing a hold for the apportionments of the transaction amount, the group processor 104 may notify at least one of the user devices 102a-c (e.g., first user device 102a) that that the authentication and authorization steps have been completed.

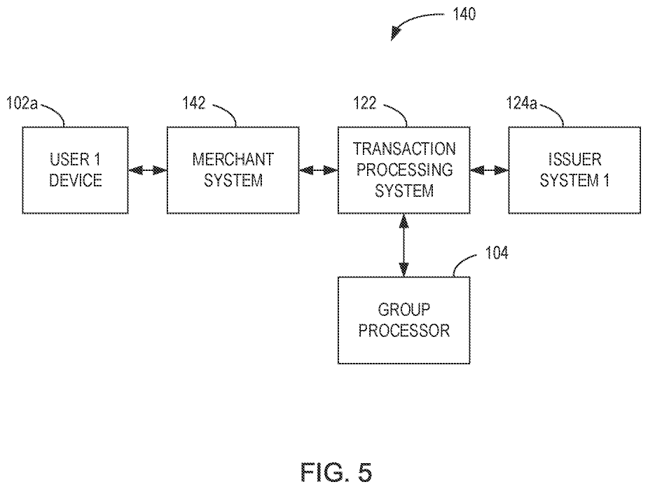

Referring to FIG. 5, system 140 is shown for processing a group payment transaction according to some non-limiting embodiments or aspects. The first user device 102a may generate a transaction request message and transmit the transaction request message to the merchant system 142 to initiate processing of the group payment transaction with the merchant system 142. In some non-limiting embodiments or aspects the merchant system 142 may not be involved in the previously described authentication and authorization process with the exception of providing the first user device 102a the transaction amount for the proposed transaction.

The transaction request message may comprise the group payment credential. The transaction request message may not comprise the first individual payment credential or any other individual payment credential of a group user.

With continued reference to FIG. 5, in response to receiving the transaction request message, the merchant system 142 may automatically generate an authorization request. The authorization request may comprise the group payment credential. The authorization request may comprise transaction data for processing the payment transaction, such as the data elements specified in ISO 8583. For example, the authorization request may comprise the transaction amount, a merchant identifier, and the like. The merchant system 142 may transmit the authorization request to a transaction processing system 122 of a transaction service provider associated with the group payment credential. In some non-limiting embodiments or aspects, the merchant system 142 may process the group payment transaction described herein without any modifications to its hardware, software, or the like, and the merchant system 142 may not be aware that the payment transaction is a group payment transaction or that the group payment credential does not comprise an underlying payment account, such that no modifications are required on the part of the merchant system 142 to conduct such transactions.

With continued reference to FIG. 5, the group processor 104 may generate a processing request for the group payment transaction. The processing request may comprise the first individual payment credential. The processing request may comprise the at least one authorization code associated with the group payment transaction.

In response to the transaction processing system 122 receiving the authorization request, the group processor 104 may provide the processing request to the transaction processing system 122. Providing the processing request may comprise the group processor 104 transmitting the processing request to the transaction processing system 122 and/or the transaction processing system 122 may retrieve the processing request from the group processor 104. In response to receiving the authorization request, the transaction processing system 122 may determine that the payment credential contained therein is a group payment credential and, in response, automatically obtain the processing request from the group processor 104.

With continued reference to FIG. 5, the transaction processing system 122 may transmit the processing request to the first issuer system 124a to cause the first issuer system 124a to process the group payment transaction with the first individual payment credential. The transaction processing system 122 may further include additional transaction data in the processing request based on the authorization request received from the merchant system 142. For example, the transaction processing system 122 may include transaction amount, merchant identifier, or any other data elements from ISO 8583 in the processing request.

With continued reference to FIG. 5, in response to receiving the processing request, the first issuer system 124a may initiate further processing of the group payment transaction to completion. This may include the first issuer system 124a confirming authorization of the group payment transaction for the transaction amount. Further processing may also include initiating clearing and/or settlement of the group payment transaction for the transaction amount with the first issuer system 124a, which may include automatically debiting the transaction amount from the payment account associated with the first individual payment credential. Further processing may also include automatically removing the hold on the payment account associated with the first individual payment credential. The initiation of clearing and/or settlement and/or the release of the hold from the payment account may be automatically executed in response to determining that the authorization code in the processing request matches the authorization code stored by the first issuer system 124a in association with the hold and/or the group payment transaction.

Referring again to FIG. 3, a hold release message may be transmitted from the group processor 104 and/or the transaction processing system 122 to each of the issuer systems 124b-c associated with the individual payment credentials of the users used to settle with the user associated with the first individual payment credential. The hold release message may be transmitted in response to the further processing executed by the first issuer system 124a, such as the release of the hold thereby and/or the clearing and/or settlement of the transaction amount. The hold release messages may comprise the authorization code. The holds on the payment accounts of the group users may be automatically released based on the authorization code in the hold release message matching the authorization code stored by the issuer systems 124b-c in association with the hold and/or the group payment transaction.

In some non-limiting embodiments or aspects, clearing and/or settlement of the payment transaction, including apportionments of the transaction amount due by the other users to the user associated with the first individual payment credential may be initiated. Clearing and/or settlement of the apportionments of the transaction amount may be initiated by the issuer systems 124b-c in response to at least one of receiving the hold release message, receiving a separate message, and/or releasing the hold from the payment accounts. Clearing and/or settlement of the apportionments may be conducted from the pooled account previously described.

In some non-limiting embodiments or aspects, clearing and/or settlement of the apportionments of the transaction amount due by the other users to the user associated with the first individual payment credential may include automatically debiting the corresponding apportioned portion of the transaction amount from payment accounts associated with the group users (and/or the pooled account) and automatically crediting the payment account of the user associated with the first individual payment credential at least a portion of the amount debited from the payment accounts associated with the other users. The at least a portion of the amount debited from the payment accounts may be the transaction amount less the apportionment owed by the user associated with the first individual payment credential.

The automatic crediting to the payment account of the user associated with the first individual payment credential and/or the automatic debiting of the payment accounts of the other group users may be executed in real-time relative to clearing and/or settlement of the transaction amount with the merchant system 142 with the payment account associated with the first individual payment credential. In some non-limiting embodiments or aspects, clearing and/or settlement of the apportionments of the transaction amount due by the other users to the user associated with the first individual payment credential may occur before clearing and/or settlement of the transaction amount with the merchant system 142 with the payment account associated with the first individual payment credential, with the two steps executed in real-time relative to one another. In this way, the user associated with the payment credential may be reimbursed for the group payment transaction by the other users in real-time relative to the payment account of the first individual payment credential being debited.

With continued reference to FIG. 3, in some non-limiting embodiments or aspects, the reward amount for the group payment transaction may be determined as previously described, such as based on the payment device data associated with the first individual payment credentials and the transaction data associated with the group payment transaction. In the non-limiting example provided herein, the first individual payment credential comprises a reward amount of $5.

As opposed to the reward amount being credited only to the payment account of the user associated with the first individual payment credential, the transaction processing system 122 and/or the group processor 104 may determine an apportionment of the reward amount among the plurality of users of the group engaged in the group payment transaction. In some non-limiting embodiments, apportioning the reward amount may comprise evenly apportioning the reward amount among the plurality of users of the group engaged in the group payment transaction (e.g., evenly apportioning the $5 reward amount among the first-third users). In some non-limiting embodiments, apportioning the reward amount may comprise apportioning the reward amount among the plurality of users of the group engaged in the group payment transaction based on each user's apportionment of the transaction amount (e.g., the first user apportioned 40% of the $5 reward amount, and the second and third users each apportioned 30% of the $5 reward amount).

In response to the reward amount being apportioned, each account of the plurality of users of the group engaged in the group payment transaction may be automatically credited the corresponding apportionment of the reward amount. In some non-limiting embodiments or aspects, the first issuer system 124a may owe the reward amount, such that the first issuer system 124a automatically credits the corresponding apportionment of the reward amount to the payment accounts of the users, which may be credited directly and/or indirectly using the transaction processing system 122 and/or the group processor 104.

Referring again to FIG. 5, in some non-limiting embodiments or aspects, a single user of the group (e.g., the first user) may initiate a payment transaction using the group payment credential in which the first user is responsible for 100% of the transaction amount. This may be because the first user elects to be responsible for 100% or because the other group users declined a proposed group payment transaction, but the first user elected to continue by covering 100% of the transaction amount. In such non-limiting embodiments, the first user device 102a may generate a transaction request message and transmit the transaction request message to the merchant system 142. The transaction request message may comprise the group payment credential. The transaction request message may comprise an indicator that the first user is the only user of the group involved in the payment transaction.

The merchant system 142 may generate and transmit an authorization request to the transaction processing system 122, and the authorization request may comprise the group payment credential and the indicator that the first user is the only user of the group involved in the payment transaction. The transaction processing system 122 may determine that the payment credential is the group payment credential and that the first user is the only group user in the payment transaction. In response, the transaction processing system 122 may automatically obtain an individual payment credential of the first user (e.g., the first individual payment credential) from the group processor 104, in order to convert the group payment transaction into an individual payment transaction. The transaction processing system 122 may transmit a processing request to the first issuer system 124a (e.g., corresponding to the individual payment credential of the first user). The first issuer system 124a may determine an authorization decision (e.g., authorize and/or decline) for the payment transaction and generate and transmit a processing response to the transaction processing system 122 containing the authorization decision. The transaction processing system 122 may further process the payment transaction based on the authorization decision.

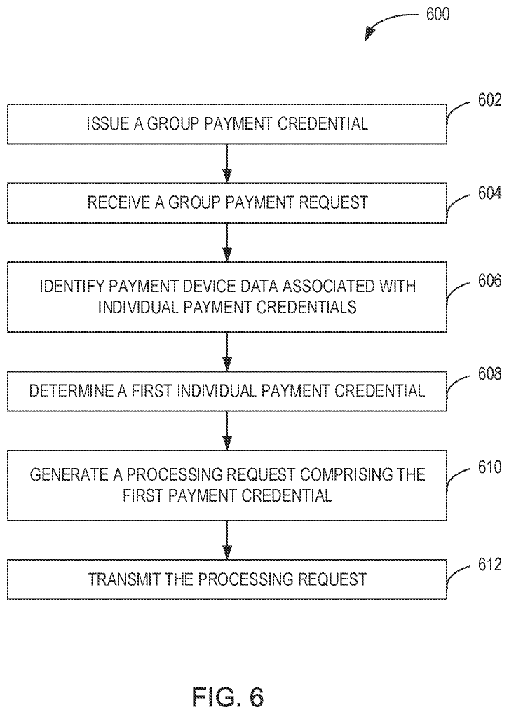

Referring to FIG. 6, a computer-implemented method 600 is shown for processing a group payment credential according to some non-limiting embodiments or aspects. It will be appreciated that one or more steps of method 600 may be executed automatically and/or in response to a preceding step. Further, non-limiting embodiments may include additional, fewer, and/or a different order of steps.

At a step 602, the method 600 may include issuing, with at least one processor (e.g., group processor 104), a group payment credential to a payment group comprising a plurality of users, each user comprising an individual payment credential associated with a payment device, the group payment credential configured to initiate electronic payment transactions of the payment group.

At a step 604, the method 600 may include receiving, with at least one processor (e.g., group processor 104), a group payment request initiated using the group payment credential, the group payment request associated with a payment transaction having a transaction amount.

At a step 606, the method 600 may include, in response to receiving the group payment request, identifying, with at least one processor (e.g., group processor 104), payment device data associated with the individual payment credentials of each user in the payment group;

At a step 608, the method 600 may include determining, with at least one processor (e.g., group processor 104), a first individual payment credential from the individual payment credentials based on the payment device data associated with the individual payment credentials and transaction data associated with the payment transaction.

At a step 610, the method 600 may include generating, with at least one processor (e.g., group processor 104 and/or transaction processing system 122 and/or user device 102a), a processing request comprising the first individual payment credential.

At a step 612, the method 600 may include transmitting, with at least one processor (e.g., group processor 104 and/or transaction processing system 122 and/or user device 102a), the processing request to an issuer system (e.g., issuer system 124a) corresponding to the first individual payment credential to cause the issuer system to process the payment transaction.

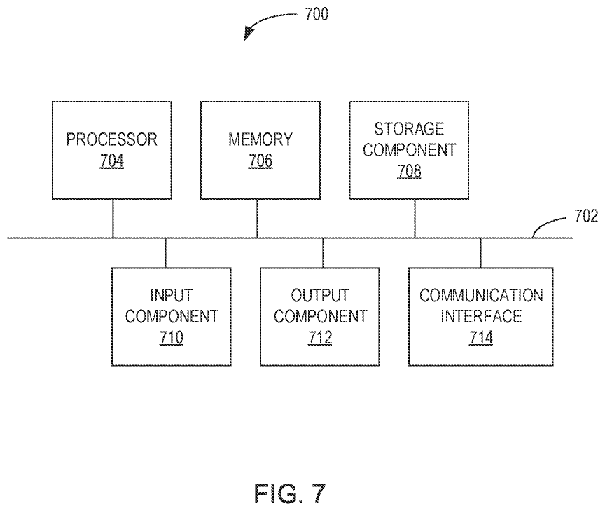

Referring now to FIG. 7, shown is a diagram of example components of a device 700 according to non-limiting embodiments or aspects. Device 700 may correspond to one or more devices of user devices 102a-c, group processor 104, transaction processing system 122, issuer systems 124a-c, and/or merchant system 142, as an example. In some non-limiting embodiments or aspects, such systems or devices in FIGS. 1-5 may include at least one device 700 and/or at least one component of device 700. The number and arrangement of components shown in FIG. 7 are provided as an example. In some non-limiting embodiments or aspects, device 700 may include additional components, fewer components, different components, or differently arranged components than those shown in FIG. 7. Additionally, or alternatively, a set of components (e.g., one or more components) of device 700 may perform one or more functions described as being performed by another set of components of device 700.

As shown in FIG. 7, device 700 may include bus 702, processor 704, memory 706, storage component 708, input component 710, output component 712, and communication interface 714. Bus 702 may include a component that permits communication among the components of device 700. In some non-limiting embodiments or aspects, processor 704 may be implemented in hardware, firmware, or a combination of hardware and software. For example, processor 704 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 706 may include random access memory (RAM), read only memory (ROM), and/or another type of dynamic or static storage device (e.g., flash memory, magnetic memory, optical memory, etc.) that stores information and/or instructions for use by processor 704.

With continued reference to FIG. 7, storage component 708 may store information and/or software related to the operation and use of device 700. For example, storage component 708 may include a hard disk (e.g., a magnetic disk, an optical disk, a magneto-optic disk, a solid state disk, etc.) and/or another type of computer-readable medium. Input component 710 may include a component that permits device 700 to receive information, such as via user input (e.g., a touch screen display, a keyboard, a keypad, a mouse, a button, a switch, a microphone, etc.). Additionally, or alternatively, input component 710 may include a sensor for sensing information (e.g., a global positioning system (GPS) component, an accelerometer, a gyroscope, an actuator, etc.). Output component 712 may include a component that provides output information from device 700 (e.g., a display, a speaker, one or more light-emitting diodes (LEDs), etc.). Communication interface 714 may include a transceiver-like component (e.g., a transceiver, a separate receiver and transmitter, etc.) that enables device 700 to communicate with other devices, such as via a wired connection, a wireless connection, or a combination of wired and wireless connections. Communication interface 714 may permit device 700 to receive information from another device and/or provide information to another device. For example, communication interface 714 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 700 may perform one or more processes described herein. Device 700 may perform these processes based on processor 704 executing software instructions stored by a computer-readable medium, such as memory 706 and/or storage component 708. A computer-readable medium may include any non-transitory memory device. A memory device includes memory space located inside of a single physical storage device or memory space spread across multiple physical storage devices. Software instructions may be read into memory 706 and/or storage component 708 from another computer-readable medium or from another device via communication interface 714. When executed, software instructions stored in memory 706 and/or storage component 708 may cause processor 704 to perform one or more processes described herein. Additionally, or alternatively, hardwired circuitry may be used in place of or in combination with software instructions to perform one or more processes described herein. Thus, embodiments described herein are not limited to any specific combination of hardware circuitry and software. The term “programmed or configured,” as used herein, refers to an arrangement of software, hardware circuitry, or any combination thereof on one or more devices.

Although embodiments have been described in detail for the purpose of illustration, it is to be understood that such detail is solely for that purpose and that the disclosure is not limited to the disclosed embodiments or aspects, but, on the contrary, is intended to cover modifications and equivalent arrangements that are within the spirit and scope of the appended claims. For example, it is to be understood that the present disclosure contemplates that, to the extent possible, one or more features of any embodiment or aspect can be combined with one or more features of any other embodiment or aspect.

What is claimed is:

1. A computer-implemented method comprising:
issuing, with at least one processor, a group payment credential to a payment group comprising a plurality of users, each user comprising an individual payment credential associated with a payment device, the group payment credential configured to initiate electronic payment transactions of the payment group;
receiving, with at least one processor, a group payment request initiated using the group payment credential, the group payment request associated with a payment transaction having a transaction amount;
in response to receiving the group payment request, identifying, with at least one processor, payment device data associated with the individual payment credentials of each user in the payment group;
determining, with at least one processor, a first individual payment credential from the individual payment credentials based on the payment device data associated with the individual payment credentials and transaction data associated with the payment transaction;
generating, with at least one processor, a processing request comprising the first individual payment credential; and
transmitting, with at least one processor, the processing request to an issuer system corresponding to the first individual payment credential to cause the issuer system to process the payment transaction.

2. The computer-implemented method of claim 1, wherein determining the first individual payment credential comprises:
determining a reward amount for each of the individual payment credentials based on the payment device data associated with the individual payment credentials and the transaction data associated with the payment transaction;
determining that the first individual payment credential has a highest reward amount compared the other individual payment credentials, wherein the reward amount for the first individual payment credential comprises a first reward amount.

3. The computer-implemented method of claim 2, further comprising during settlement of the payment transaction:
determining, with at least one processor, an apportionment of the first reward amount among the plurality of users; and
automatically crediting, with at least one processor, each account of the plurality of users with a corresponding apportionment of the first reward amount.

4. The computer-implemented method of claim 1, further comprising:
initiating, with a first user device associated with a first user in the payment group, the payment transaction by generating and transmitting a transaction proposal message to each second user device of a plurality of second users in the payment group, the transaction proposal message comprising an apportionment of the transaction amount for each user in the payment group;
receiving a transaction proposal response from each of the second user devices, the transaction proposal responses comprising a transaction approval indicator; and
generating and transmitting the group payment request.

5. The computer-implemented method of claim 1, wherein the group payment request does not comprise the first individual payment credential.

6. The computer-implemented method of claim 1, wherein the first individual payment credential corresponds to a first user in the payment group, wherein the payment group comprises at least one second user, the at least one second user having a second individual payment credential issued by at least one second issuer system, wherein each user in the payment group is apportioned a portion of the transaction amount, the computer-implemented method further comprising:
for each user of the at least one second user, authorizing, with the at least one second issuer system, the second user for the corresponding apportioned portion of the transaction amount; and
initiating clearing and/or settlement of the payment transaction.

7. The computer-implemented method of claim 6, further comprising:
for each user the at least one second user, automatically placing, with the at least one second issuer system, a hold on a payment account associated with the second user for the corresponding apportioned portion of the transaction amount.

8. The computer-implemented method of claim 7, wherein a unique identifier associated with the payment transaction is stored in association with each hold placed on the payment account associated with the at least one second user, the computer-implemented method further comprising:
for each user of the at least one second user:
receiving, with the at least one second issuer system, a hold release message comprising the unique identifier; and
automatically releasing, with the at least one second issuer system, the hold on the payment account associated with the second user based on the unique identifier in the hold release message matching the unique identifier stored in association with the hold.

9. The computer-implemented method of claim 6, wherein clearing and/or settlement of the payment transaction comprises:
automatically debiting, with at least one processor, the corresponding apportioned portion of the transaction amount from a payment account associated with each of the at least one second user; and
automatically crediting, with at least one processor, a payment account of the first user at least a portion of the amount debited from the payment accounts associated with the at least one second user.

10. The computer-implemented method of claim 9, wherein the automatic debiting and/or the automatic crediting are executed in real-time relative to clearing and/or settlement of the transaction amount with a merchant system with a payment account associated with the first individual payment credential.

11. A system comprising at least one processor programmed or configured to:
issue a group payment credential to a payment group comprising a plurality of users, each user comprising an individual payment credential associated with a payment device, the group payment credential configured to initiate electronic payment transactions of the payment group;
receive a group payment request initiated using the group payment credential, the group payment request associated with a payment transaction having a transaction amount;
in response to receiving the group payment request, identify payment device data associated with the individual payment credentials of each user in the payment group;
determine a first individual payment credential from the individual payment credentials based on the payment device data associated with the individual payment credentials and transaction data associated with the payment transaction;
generate a processing request comprising the first individual payment credential; and
transmit the processing request to an issuer system corresponding to the first individual payment credential to cause the issuer system to process the payment transaction.

12. The system of claim 11, wherein determining the first individual payment credential comprises:
determining a reward amount for each of the individual payment credentials based on the payment device data associated with the individual payment credentials and the transaction data associated with the payment transaction;
determining that the first individual payment credential has a highest reward amount compared the other individual payment credentials, wherein the reward amount for the first individual payment credential comprises a first reward amount.

13. The system of claim 12, wherein the at least one processor is programmed or configured, during settlement of the payment transaction, to:
determine an apportionment of the first reward amount among the plurality of users; and
automatically credit each account of the plurality of users with a corresponding apportionment of the first reward amount.

14. The system of claim 11, wherein the at least one processor is programmed or configured to:
initiate, with a first user device associated with a first user in the payment group, the payment transaction by generating and transmitting a transaction proposal message to each second user device of a plurality of second users in the payment group, the transaction proposal message comprising an apportionment of the transaction amount for each user in the payment group;
receive a transaction proposal response from each of the second user devices, the transaction proposal responses comprising a transaction approval indicator; and
generate and transmit the group payment request.

15. The system of claim 11, wherein the group payment request does not comprise the first individual payment credential.

16. The system of claim 11, wherein the first individual payment credential corresponds to a first user in the payment group, wherein the payment group comprises at least one second user, the at least one second user having a second individual payment credential issued by at least one second issuer system, wherein each user in the payment group is apportioned a portion of the transaction amount, wherein the at least one processor is programmed or configured to:
for each user of the at least one second user, authorize, with the at least one second issuer system, the second user for the corresponding apportioned portion of the transaction amount; and
initiate clearing and/or settlement of the payment transaction.

17. The system of claim 16, wherein the at least one processor is programmed or configured to:
for each user the at least one second user, automatically place, with the at least one second issuer system, a hold on a payment account associated with the second user for the corresponding apportioned portion of the transaction amount.

18. The system of claim 17, wherein a unique identifier associated with the payment transaction is stored in association with each hold placed on the payment account associated with the at least one second user, wherein the at least one processor is programmed or configured to:
for each user of the at least one second user:
receive, with the at least one second issuer system, a hold release message comprising the unique identifier; and
automatically release, with the at least one second issuer system, the hold on the payment account associated with the second user based on the unique identifier in the hold release message matching the unique identifier stored in association with the hold.

19. The system of claim 16, wherein the at least one processor is programmed or configured, during clearing and/or settlement of the payment transaction, to:
automatically debit the corresponding apportioned portion of the transaction amount from a payment account associated with each of the at least one second user; and
automatically credit a payment account of the first user at least a portion of the amount debited from the payment accounts associated with the at least one second user.

20. A computer program product comprising at least one non-transitory computer-readable medium including program instructions that, when executed by at least one processor, cause the at least one processor to:
issue a group payment credential to a payment group comprising a plurality of users, each user comprising an individual payment credential associated with a payment device, the group payment credential configured to initiate electronic payment transactions of the payment group;
receive a group payment request initiated using the group payment credential, the group payment request associated with a payment transaction having a transaction amount;
in response to receiving the group payment request, identify payment device data associated with the individual payment credentials of each user in the payment group;
determine a first individual payment credential from the individual payment credentials based on the payment device data associated with the individual payment credentials and transaction data associated with the payment transaction;
generate a processing request comprising the first individual payment credential; and
transmit the processing request to an issuer system corresponding to the first individual payment credential to cause the issuer system to process the payment transaction.
